(19) United States
(12) Patent Application Publication
(10) Pub. No.: US 2021/0306124 A1
(43) Pub. Date: Sep. 30, 2021

(54) SCHEDULING RELEASE FEEDBACK

(71) Applicant: Nokia Technologies Oy, Espoo (FI)

(72) Inventors: Tao TAO, Shanghai (CN); Chunli WU, Beijing (CN); Renato Barbosa ABREU, Aalborg (DK); Karol SCHOBER, Helsinki (FI)

(21) Appl. No.: 17/195,142

(22) Filed: Mar. 8, 2021

(30) Foreign Application Priority Data
Mar. 26, 2020 (CN) PCT/CN2020/081502

(51) Int. Cl. H04L 5/00; H04L 1/18; H04W 72/12

(52) U.S. Cl. CPC H04L 5/0053; H04W 72/1263; H04L 1/1812

(57) ABSTRACT

Example embodiments of the present disclosure relate to feedback to scheduling release feedback. According to embodiments of the present disclosure, there is provided a solution for feedback to a scheduling release indication. The first device receives control information which comprises a scheduling release indication. The scheduling release indication is associated with a hybrid automatic repeat request (HARQ) process. The first device transmits a feedback to the release indication on an occasion allocated for the HARQ process. In this way, the second device does not need to transmit the scheduling release indication for several times, thereby saving resources. Further, overhead can be saved.

### FIELD

Embodiments of the present disclosure generally relate to the field of telecommunication and in particular, to methods, devices, apparatuses and computer readable storage medium for scheduling release feedback.

### BACKGROUND

With development of communication systems, more and more technologies have been proposed. For example, a new radio access system, which is also called a NR system or NR network, is being developed. NR unlicensed (NR-U) communication has also been proposed to improve communication capacities. In the NR-U communication system, a base station needs to schedule terminal devices.

### SUMMARY

In general, example embodiments of the present disclosure provide a solution for feedback to scheduling release.

In a first aspect, there is provided a first device. The first deice comprises at least one processor; and at least one memory including computer program codes; the at least one memory and the computer program codes are configured to, with the at least one processor, cause the first device to: receive, from a second device, control information comprising a scheduling release indication for releasing a configured resource. The first deice is also caused to select a hybrid automatic repeat request, HARQ, process to be associated with the scheduling release indication. The first device is further caused to transmit a feedback to the scheduling release indication to the second device on an occasion allocated for the selected HARQ process.

In a second aspect, there is provided a second device. The second deice comprises at least one processor; and at least one memory including computer program codes; the at least one memory and the computer program codes are configured to, with the at least one processor, cause the second device to transmit control information comprising a scheduling release indication to a first device. The second device is further caused to receive from the first device a feedback on an occasion allocated for a hybrid automatic repeat request, HARQ, process associated with the scheduling release indication.

In a third aspect, there is provided a method. The method comprises receiving, at a first device and from a second device, control information comprising a scheduling release indication for releasing a configured resource. The method also comprises selecting a hybrid automatic repeat request, HARQ, process to be associated with the scheduling release indication. The method further comprises transmitting a feedback to the scheduling release indication to the second device on an occasion allocated for the selected HARQ process.

In a fourth aspect, there is provided a method. The method comprises transmitting, at a second device, control information comprising a scheduling release indication to a first device. The method also comprises receiving from the first device a feedback on an occasion allocated for a hybrid automatic repeat request, HARQ, process associated with the scheduling release indication.

In a fifth aspect, there is provided an apparatus. The apparatus comprises means for receiving, at a first device and from a second device, control information comprising a scheduling release indication for releasing a configured resource; means for selecting a hybrid automatic repeat request, HARQ, process to be associated with the scheduling release indication; and means for transmitting a feedback to the scheduling release indication to the second device on an occasion allocated for the selected HARQ process.

In a sixth aspect, there is provided an apparatus. The apparatus comprises means for transmitting, at a second device, control information comprising a scheduling release indication to a first device; and means for receiving from the first device a feedback on an occasion allocated for a hybrid automatic repeat request, HARQ, process associated with the scheduling release indication.

In a seventh aspect, there is provided a computer readable medium. The computer readable medium comprises program instructions for causing an apparatus to perform at least the method according to any one of the above third and fourth aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling flow for reporting candidate beams according to some embodiments of the present disclosure;

FIGS. 3A and 3B illustrate block diagrams of HARQ process association for scheduling release indication according to some example embodiments of the present disclosure, respectively;

FIG. 4 illustrates a flowchart of a method implemented at a first apparatus according to some example embodiments of the present disclosure;

FIG. 5 illustrates a flowchart of a method implemented at a second apparatus according to some other example embodiments of the present disclosure;

FIG. 6 illustrates a simplified block diagram of an apparatus that is suitable for implementing example embodiments of the present disclosure; and

FIG. 7 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:

(a) hardware-only circuit implementations (such as implementations in only analog and/or digital circuitry) and

(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and

(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, an Integrated and Access Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

According to conventional technologies, there are various HARQ-ACK codebooks (CB). New Radio system supports at the moment three types of HARQ-ACK CBs. Type-1 CB, is a fixed sized CB and it is based on configured PDSCH-to-HARQ-ACK timing and time domain allocations. Type-2 CB, is a CB with dynamic size, which is based on actual number of received physical downlink shared channel (PDSCH) or physical downlink control channel (PDCCH).

In CB type-3, the UE may report ACK/NACK for all HARQ processes among cells of physical uplink control channel (PUCCH) group. A UE may not be able to transmit HARQ-ACK at the intended point in time due to listen-before-talk (LBT) failure. A fallback mechanism for the network device to explicitly poll HARQ-feedback is needed. Based on radio resource control (RRC) configuration, the UE may report true HARQ-ACK only once in one slot CB or default value of NACK when CB is configured not to comprise new data indicator. The UE may support multiple transmitting opportunities but single transmission.

A CB may be configured to comprise latest new data indicator per process, which may double its size, on the other hand, UE may always report true ACK/NACK for the HARQ process. Further, in the NR-U, downlink semi-persistent scheduling (SPS) may be employed, which is a grant-less operation. A network device may configure periodicity of downlink assignment, HARQ processes, PUCCH resource for feedback and the like to a terminal device. Table 1 shows pseudocode of SPS configuration.

TABLE 1
-- ASN1START
-- TAG-SPS-CONFIG-START

| | |
|---|---|
| SPS-Config ::= | SEQUENCE { |
| periodicity | ENUMERATED {ms10, ms20, ms32, ms40, ms64, |
| ms80, ms128, ms160, ms320, ms640, | |
| | spare6, spare5, spare4, spare3, |
| spare2, spare1}, | |
| nrofHARQ-Processes | INTEGER (1..8), |
| n1PUCCH-AN | PUCCH-ResourceId |
| OPTIONAL, -- Need M | |
| mcs-Table | ENUMERATED {qam64LowSE} |
| OPTIONAL, -- Need S | |
| ... | |
| } | |
| -- TAG-SPS-CONFIG-STOP | |
| -- ASN1STOP | |

The downlink (DL) SPS is activated by activation downlink control information of the periodic transmission, except for those the unused field are set to 0 which are used for validation of DCI for activation/deactivation. This means that when DL SPS is activated, UE provides HARQ-ACK K1 slots after each PDSCH transmission in a PUCCH resource (in case only HARQ-ACK for DL SPS is transmitted), where K1 and corresponding time domain allocation in a slot (Start and Length Indicator Value (SLIV)) is indicated by a field in the activation DCI.

The PUCCH resource used for SPS HARQ-ACK is pointed by the RRC parameter. According to conventional technologies, where UE can have more than one active SPS PDSCH configurations, UE is provided by SPS-PUCCH-AN-List a set of PUCCH resources and determines a PUCCH resource based on the payload size of the UCI. Otherwise, if HARQ-ACK for SPS PDSCH is multiplexed with HARQ-ACK for dynamic PDSCH (i.e. both feedbacks are transmitted in same slot), the PUCCH will be according the DCI scheduling dynamic PDSCH.

SPS assignment is released by a deactivation PDCCH, called DL SPS release. However, how to associate DL SPS release PDCCH with a HARQ process to make Type-3 CB support HARQ-ACK for SPS release needs to be studied. In some conventional technologies, the network device needs to transmit DL SPS release PDCCH again and again until PDCCH reception and UL LBT succeed. Retransmission of SPS release PDCCH (due to UL LBT failure before ACK/NACK feedback) results in additional transmission overhead and latency. In other conventional technologies, gluing DL SPS configuration CB (1 container per DL SPS configuration) to HARQ-process CB (i.e. current TYPE-3) which results to increase UCI feedback overhead, because HARQ-ACK is reported every time, even when no DL SPS release is scheduled. In TYPEI CB, a location in the Type-1 HARQ-ACK codebook for HARQ-ACK information corresponding to a single SPS PDSCH release is same as for a corresponding SPS PDSCH reception. This means that in TYPEI CB the location of HARQ-ACK for SPS PDSCH release is based on Start and Length Indicator Value (SLIV) in activation DCI and slot of SPS PDSCH release DCI. However, this method is not applicable for Type-3 CB, therefore, it does not solve the problem of one-shot feedback for SPS release in NR-U.

In order to solve at least part of the above problems. a solution on transmitting feedback to a scheduling release is needed. According to embodiments of the present disclosure, there is provided a solution for feedback to a scheduling release indication. The first device receives control information which comprises a scheduling release indication. The scheduling release indication is associated with a HARQ process. The first device transmits a feedback to the release indication on an occasion allocated for the selected HARQ process. In this way, the second device does not need to transmit the scheduling release indication for several times, thereby saving resources. Further, overhead can be saved and unnecessary interference cause by UE missing DL SPS release may be avoided in the network.

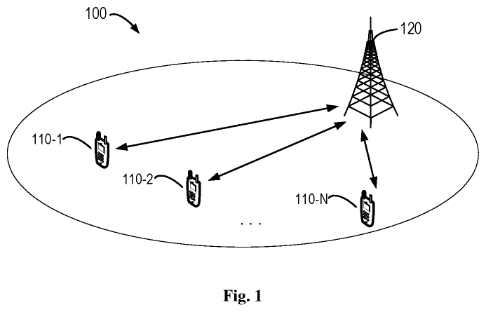

FIG. 1 illustrates a schematic diagram of a communication environment 100 in which embodiments of the present disclosure can be implemented. The communication environment 100, which is a part of a communication network, comprises a device 110-1, a device 110-2, . . . . , a device 110-N, which can be collectively referred to as “first device(s) 110.” The communication environment 100 further comprises a second device 120 that can communicate with the first device(s) 110.

The communication environment 100 may comprise any suitable number of devices and cells. In the communication environment 100, the first device 110 and the second device 120 can communicate data and control information to each other. In the case that the first device 110 is the terminal device and the second device 120 is the network device, a link from the second device 120 to the first device 110 is referred to as a downlink (DL), while a link from the first device 110 to the second device 120 is referred to as an uplink (UL). The second device 120 and the first device 110 are interchangeable.

It is to be understood that the number of first devices and cells and their connections shown in FIG. 1 is given for the purpose of illustration without suggesting any limitations. The environment 100 may include any suitable number of devices and networks adapted for implementing embodiments of the present disclosure.

Communications in the communication environment 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

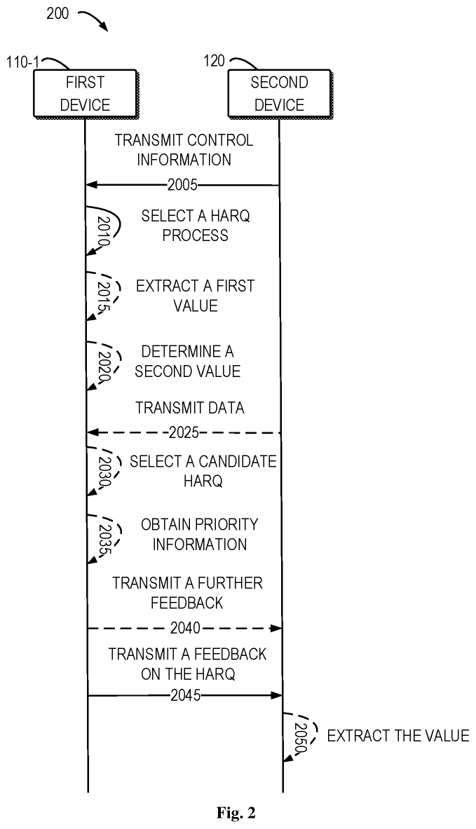

Example embodiments of the present disclosure will be described in detail below with reference to the accompanying drawings. Reference is now made to FIG. 2, which illustrates a signaling flow 200 for feedbacking to the scheduling release indication according to some example embodiments of the present disclosure. For the purpose of discussion, the process 200 will be described with reference to FIG. 1. The signaling flow 200 may involve the first device 110-1 and the second device 120.

In some embodiments, the first device 110-1 may have configured resource. Alternatively, the first device 110-1 may have semi-persist DL SPS. In case of semi persistent scheduling, the second device 120 can assign predefined chunk of radio resources for users with interval of certain periodicity which is configured by RRC configuration. Therefore, the second device 120 does not need to dynamically allocate resources with PDCCH for each transmission. This scheduling is semi-persistent in the sense that the second device 120 can change the resource allocation type or location if required for link adaptation or other factors.

The second device 120 transmits 2005 control information to the first device 110-1. The control information comprises a scheduling release indication. For example, the control information may comprise a SPS release indication. In some embodiment, the control information may be downlink control information (DCI) which is transmitted on a physical downlink control channel (PDCCH). The scheduling release indication may be used for releasing a configured scheduling resource. Alternatively, the scheduling release indication may be used for releasing a semi-static scheduling resource.

The first device 110-1 selects 2010 a HARQ process to be associated with the scheduling release indication. For example, the first device 110-1 may select the HARQ process and associate the selected HARQ process with the scheduling release indication. In some embodiments, the HARQ process may be selected based on a time slot on which the control information is received. For example, the scheduling release indication may be associated with the HARQ process of a subsequent physical downlink shared channel (PDSCH) of SPS configuration. In an example embodiment, the subsequent HARQ process which is after the last HARQ process used for the data transmission may be selected. In an example embodiment, the subsequent HARQ process may be after the last HARQ process used for the data transmission on the configured resources being released by the release indication. In this way, the second device 120 does not need to transmit the scheduling release indication for several times, thereby saving resources. The scheduling release indication may be used for releasing a configured scheduling resource. Alternatively, the scheduling release indication may be used for releasing a semi-static scheduling resource. Further, there is no additional overhead.

In some embodiments, first device 110-1 may select the HARQ process ID to associate with the release indication in CURRENT_slot based on the following:

HARQ Process ID=[floor (CURRENT_slot×10/(numberOfSlotsPerFrame×periodicity))] modulo nrofHARQ-Processes (1)

where CURRENT_slot=[(SFN×numberOfSlotsPerFrame)+slot number in the frame] of the slot where the release indication is received and numberOfSlotsPerFrame refers to the number of consecutive slots per frame.

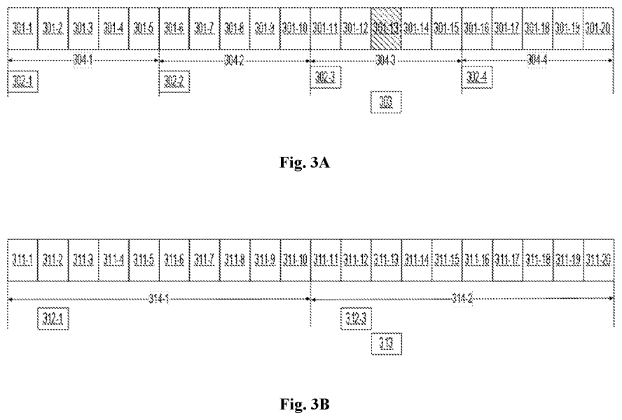

Example embodiments of selecting the HARQ process will be described with the reference to FIGS. 3A and 3B which illustrate HARQ process association for the scheduling release indication according to example embodiments of the present disclosure. The scheduling configuration shown in FIG. 3A has 5-slot periodicity and HARQ process offset is zero. There may be 20 slots (as shown as 301-1, 301-2, 301-3, 301-4, 301-5, 301-6, 301-7, 301-8, 301-9, 301-10, 301-11, 301-12, 301-13, 301-14, 301-15, 301-16, 301-17, 301-18, 301-19 and 301-20) in one frame. It should be noted that the number of slots in one frame is only an example.

There may be SPS PDSCH occasions 302-1, 302-2, 302-3 and 302-4 which are associated with the HARQ process 304-1, 304-2, 304-3 and 304-4. As shown in FIG. 3A, the first device 110-1 receives the scheduling release indication at the time slot 301-13. The scheduling release indication may be associated to HARQ process that would have been used for DL SPS PDSCH in time slot 304-16, i.e., HARQ process 304-4. For example, the first device 110-1 may select the HARQ process 304-4 and associate the selected HARQ process 304-4 with the scheduling release indication. In time slot 304-15, periodic PUCCH would be normally transmitted, but due to LBT failure it does not succeed. The second device 120 may trigger TYPE-3 CB to pull the feedback in time slot 301-20. The first device 110-1 may report ACK/NACK to the scheduling release indication in the TYPE-3 CB at position of HARQ process 304-4.

In some embodiments, multiple SPS configurations may be configured in one cell. For example, the configuration shown in FIG. 3B may also be configured. As shown in FIG. 3B, the scheduling configuration has 10-slot periodicity and HARQ process offset is 2. There may be 20 slots (as shown as 311-1, 311-2, 311-3, 311-4, 311-5, 311-6, 311-7, 311-8, 311-9, 311-10, 311-11, 311-12, 311-13, 311-14, 311-15, 311-16, 311-17, 311-18, 311-19 and 301-20) in one frame. It should be noted that the number of slots in one frame is only an example. There may be SPS PDSCH occasions 312-1, 302-2, 302-3 and 302-4 which are associated with the HARQ process 304-1, 304-2, 304-3 and 304-4.

Since the PDCCH 313 carrying the scheduling release indication and the PDSCH 312-3 are associated to the HARQ 314-2, there may be an ambiguity for HARQ process 314-2. In this situation, the feedback to the PDSCH 312-3 may be prioritized. In other words, the feedback to the PDSCH 312-3 may be transmitted instead of the feedback to the scheduling release indication. Alternatively, the feedback for the release indication may be prioritized.

In another embodiment, it could be explicitly indicated the feedback to which one is prioritized, from the second device 120 to the first device 110-1 when the release indication is sent, or from the first device 110-1 to the second device 120 when the feedback is sent.

Referring back to FIG. 2, the first device 110-1 may extract 2015 a first value from the control information. For example, the first device 110-1 may obtain a new data indicator (NDI) from the control information. If the first value is not toggled in association with previous reception of PDSCH for the configured scheduling process, the feedback to the scheduling release indication can be transmitted by the first device 110-1. Alternatively, if the first value is toggled in association with previous reception of PDSCH for the configured scheduling process, the first device 110-1 may not transmit the feedback to the scheduling release indication. For example, if the first value is “0”, it means that the first value is not toggled. In this situation, the feedback to the scheduling release can be transmitted. The first value may also be transmitted together with the feedback to the second device. Alternatively, if the first device 110-1 obtains a third value indicating “1” from PDCCH information, the first device 110-1 may determine to transmit the further feedback to the data instead of the scheduling release indication. In this way, the collision of the HARQ process can be avoided.

In other embodiments, the first device 110-1 may determine 2020 a second value (for example, NDI). For example, if the first device 110-1 detects the scheduling release indication, the first device 110-1 may determine the second value in association with the detection of the scheduling release indication. Only as an example, the second value may be “1” after the detection of the scheduling release indication. The feedback to the scheduling release indication may comprise the second value, which means the feedback is associated with the scheduling release indication. In some embodiments, the second value may be determined based on the first value. For example, if the first value indicates “0”, the second value may be “0”. Alternatively, if the first value indicates “1”, the second value may be “1”.

Alternatively, the first device 110-1 may determine a fourth value in association with the reception of data. Only as an example, the first device 110-1 may determine the fourth value to be “0” and transmit the further feedback comprising the fourth value. In this way, the second device 120 can determine that the received feedback is associated to the scheduling release indication or the data based on the value (for example, the second value or fourth value) (for example, NDI) included in the received feedback. Therefore, there is no additional overhead to distinguish feedbacks.

In some embodiments, the fourth value may be determined based on the third value. For example, if the third value indicates “1”, the fourth value may be “1”. Alternatively, if the third value indicates “0”, the fourth value may be “0”.

In some embodiments, the first value and the third value may be transmitted together, for example, two bits in the PDCCH. For example, if the first and third values indicate “00”, the first device 110-1 may determine that there is no feedback for the scheduling release indication. If the first and third values indicate “01” indicate “01”, the second value for the scheduling release indication may be “0” and the fourth value for the data may be “1”. Alternatively, the first and third values indicate “10”, the second value for the scheduling release indication may be “1” and the fourth value for the data may be “0”.

The second device 120 may transmit 2025 data on configured downlink assignment. The first device 110-1 may select 2030 a candidate HARQ for the data transmission. With reference to FIG. 3A, the second device 120 may transmit data on the PDSCH occasion 302-3. The HARQ 304-4 may be the candidate HARQ for transmitting the further feedback to the data. In such situation, the candidate HARQ process for the data transmission collides with the selected HARQ process for the scheduling release indication. The first device 110-1 may obtain 2035 priority information between the feedback to the scheduling release indication and the further feedback to the data transmission. Only as an example, the control information may have an indicator to provide the priority information. The indicator may reserve one or more bits in the control information. In this way, the priority information may be indicated dynamically to avoid collisions. Alternatively, the priority information between the feedback to the scheduling release indication and the further feedback to the data transmission may be preconfigured.

If the further feedback has higher priority than the feedback, the first device 110-1 may transmits 2040 the further feedback instead of the feedback. If the feedback has higher priority than the further feedback, the first device 110-1 may transmit 2045 the feedback on the occasion allocated for the HARQ process. For example, the feedback may be transmitted on the occasion 302-4 shown in FIG. 3A.

In some embodiments, the second device 120 may extract 2050 a value from the feedback. For example, if the aforementioned first value is extracted from the feedback, the second device 120 may determine that the feedback is associated with the scheduling release indication. Alternatively, if the feedback comprises the aforementioned second value which is different from the previous value, the feedback is associated with the scheduling release indication. In this way, the second device 120 may save frequency/time resources.

For example, in some embodiments, the different values may be preconfigured to indicate different feedback types. For example, if the second device 120 extract the second value indicating “0”, the second device 120 may determine that the feedback is associated with the scheduling release indication. It should be noted that other values may be preconfigured to be associated with the feedback to the scheduling release indication.

In other embodiments, if the first value transmitted by the second device 120 indicates “0”, the second device 120 may obtain the second value indicating “0”, which means the feedback is associated with the scheduling release indication. Alternatively, if the first value transmitted by the second device 120 indicates “1”, the second device 120 may obtain the second value indicating “1”, which means the feedback is associated with the scheduling release indication.

In some embodiments, the second device 120 may obtain the fourth value from the further feedback, which means the further feedback is in association with the reception of data. For example, according to predetermined information, the value “1” may indicate that the further feedback is associated with the data. In this situation, if the fourth value indicates “1”, the second device 120 may determine that the further feedback is associated with the data.

In other embodiments, if the third value transmitted by the second device 120 indicates “0”, the second device 120 may obtain the fourth value indicating “0”, which means the feedback is associated with the data. Alternatively, if the third value transmitted by the second device 120 indicates “1”, the second device 120 may obtain the fourth value indicating “1”, which means the feedback is associated with the data.

According to embodiments of the present disclosure, there is no additional overhead and it allows the second device 120 to pull for CB type 3 when/after the scheduling release is sent. Further, retransmission of HARQ ACK/NACK for DL SPS PDCCH is supported with CB type 3.

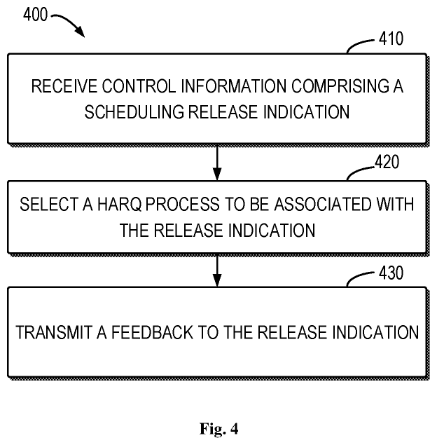

FIG. 4 shows a flowchart of an example method 400 implemented at a first device 110 in accordance with some example embodiments of the present disclosure. For the purpose of discussion, the method 400 will be described from the perspective of the first device 110-1.

At block 410, the first device 110-1 receives control information from the second device 120. The control information comprises a scheduling release indication. For example, the control information may comprise a SPS release indication. In some embodiment, the control information may be downlink control information which is transmitted on a PDCCH. The scheduling release indication may be for releasing a configured scheduling resource. Alternatively, the scheduling release indication may be used for releasing a semi-static scheduling resource.

At block 420, the first device 110-1 selects a HARQ process to be associated with the scheduling release indication. For example, the first device 110-1 may select the HARQ process and associate the selected HARQ process with the scheduling release indication. In this way, resources can be saved and no extra overhead is introduced. In some embodiments, the HARQ process may be selected based on a time slot on which the control information is received. For example, the scheduling release indication may be associated with the HARQ process of a subsequent PDSCH of SPS configuration. In an example embodiment, the subsequent HARQ process may be after the last HARQ process used for the data transmission on the configured resources being released by the release indication. For example, the identification number of the selected HARQ process is the one associated with the first occasion of configured scheduling process being after scheduling release indication.

In an example embodiment, the first device 110-1 may extract a first value from the control information. For example, the first device 110-1 may obtain a NDI from the control information. If the first value is not toggled in association with previous reception of PDSCH for the configured scheduling process, the feedback to the scheduling release indication can be transmitted by the first device 110-1. Alternatively, if the first value is toggled in association with previous reception of PDSCH for the configured scheduling process, the first device 110-1 may not transmit the feedback to the scheduling release indication. For example, if the first value is “0”, it means that the first value is not toggled. In this situation, the feedback to the scheduling release can be transmitted. The first value may also be transmitted together with the feedback to the second device. Alternatively, if the first device 110-1 obtains a third value indicating “1” from PDCCH information, the first device 110-1 may determine to transmit the further feedback to the data instead of the scheduling release indication. In this way, the collision of the HARQ process can be avoided.

In other embodiments, the first device 110-1 may determine a second value (for example, NDI). For example, if the first device 110-1 detects the scheduling release indication, the first device 110-1 may determine the second value in association with the detection of the scheduling release indication. Only as an example, the second value may be “1” after the detection of the scheduling release indication. The feedback to the scheduling release indication may comprise the second value, which means the feedback is associated with the scheduling release indication. Alternatively, the first device 110-1 may determine a fourth value in association with the reception of data. Only as an example, the first device 110-1 may determine the fourth value to be “0” and transmit the further feedback comprising the fourth value. In this way, the second device 120 can determine that the received feedback is associated to the scheduling release indication or the data based on the value (for example, NDI) included in the received feedback. Therefore, there is no additional overhead to distinguish feedbacks.

At block 430, the first device 110 transmits the feedback to the scheduling release indication to the second device 120 on an occasion allocated for the HARQ process. In some embodiments, the first device 110-1 may receive data on configured downlink assignment. The first device 110-1 may select a candidate HARQ for the data transmission. With reference to FIG. 3A, the second device 120 may transmit data on the PDSCH occasion 302-3. The HARQ 304-4 may be the candidate HARQ for transmitting the further feedback to the data. In such situation, the candidate HARQ process for the data transmission collides with the selected HARQ process for the scheduling release indication. The first device 110-1 may obtain priority information between the feedback to the scheduling release indication and the further feedback to the data transmission. Only as an example, the control information may have an indicator to provide the priority information. The indicator may reserve one or more bits in the control information. In this way, the priority information may be configured dynamically to avoid collisions. Alternatively, the priority information between the feedback to the scheduling release indication and the further feedback to the data transmission may be preconfigured.

If the further feedback has higher priority than the feedback, the first device 110-1 may transmits the further feedback instead of the feedback. If the feedback has higher priority than the further feedback, the first device 110-1 may transmit the feedback.

According to embodiments of the present disclosure, there is no additional overhead in the TYPE-3 CB and it allows the second device 120 to pull for TYPE-3 CB when/after the scheduling release e is sent. Further, retransmission of HARQ ACK/NACK for DL SPS PDCCH is supported with TYPE-3 CB.

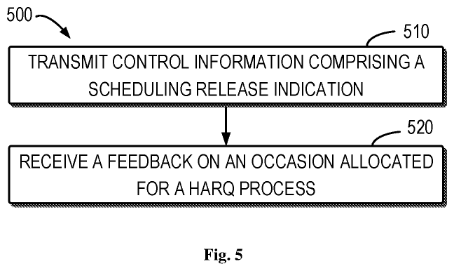

FIG. 5 shows a flowchart of an example method 500 implemented at a second device 120 in accordance with some example embodiments of the present disclosure. For the purpose of discussion, the method 500 will be described from the perspective of the second device 120.

At block 510, the second device 120 transmits control information to the first device 110-1. The control information comprises a scheduling release indication. For example, the control information may comprise a SPS release indication. In some embodiment, the control information may be downlink control information which is transmitted on a PDCCH. The scheduling release indication may be for a configured scheduling release. Alternatively, the scheduling release indication may be used for a semi-static scheduling release.

In some embodiments, the second device 120 may determine a value which may be toggled in association with the scheduling release indication. For example, the second device 120 may determine the NDI for the HARQ process. Only as an example, the second device 120 may determine “0” for the scheduling release indication.

At block 520, the second device 120 receives a feedback from the first device 110-1 on an occasion allocated for a HARQ process. In some embodiments, the second device 120 may extract a value from the feedback. For example, if the aforementioned first value is extracted from the feedback, the second device 120 may determine that the feedback is associated with the scheduling release indication. Alternatively, if the feedback comprises the aforementioned second value which is different from the previous value, the feedback is associated with the scheduling release indication.

In some example embodiments, a first apparatus capable of performing any of the method 400 (for example, the first device 110) may comprise means for performing the respective operations of the method 400. The means may be implemented in any suitable form. For example, the means may be implemented in a circuitry or software module. The first apparatus may be implemented as or included in the first device 110. In some embodiments, the means may comprise at least one processor and at least one memory including computer program code. The at least one memory and computer program code are configured to, with the at least one processor, cause performance of the apparatus.

In some embodiments, the apparatus comprises means for receiving, at a first device and from a second device, control information comprising a scheduling release indication for releasing a configured resource; means for selecting a hybrid automatic repeat request, HARQ, process to be associated with the scheduling release indication; and means for transmitting a feedback to the scheduling release indication to the second device on an occasion allocated for the selected HARQ process.

In some embodiments, the HARQ process is selected based on a time slot on which the control information is received.

In some embodiments, the scheduling release indication is for releasing a configured resource release or a semi-static scheduling resource.

In some embodiments, the means for selecting the HARQ process comprises means for selecting a subsequent HARQ process after a last HARQ process used for data transmission as the HARQ process.

In some embodiments, the apparatus further comprises mans for releasing data transmission on the configured resource.

In some embodiments, the means for transmitting the feedback comprises means for extracting a first value from the control information, the first value being toggled in association with the scheduling release indication; and means for transmitting the first value as at least a part of the feedback to the second device.

In some embodiments, the means for transmitting the feedback comprises: means for in response to receiving the scheduling release indication, determining a second value which is toggled in association with the reception of the scheduling release indication; and means for transmitting the second value as at least a part of the feedback to the second device.

In some embodiments, the apparatus further comprises means for in response to receiving data from the second device, selecting a candidate HARQ process; means for in accordance with a determination that the candidate HARQ process collides with the HARQ process, extracting a third value from the control information, the third value being toggled in association with the data; and means for transmitting a further feedback to the data to the second device for the HARQ process.

In some embodiments, the apparatus further comprises means for in response to receiving data from the second device, selecting a candidate HARQ process; means for in accordance with a determination that the candidate HARQ process collides with the HARQ process, determining a fourth value which is toggled in association with the reception of the data; and means for transmitting a further feedback to the second device, the further feedback comprising the fourth value.

In some embodiments, the apparatus further comprises means for in response to receiving data from the second device, selecting a candidate HARQ process; and means for in accordance with a determination that the candidate HARQ process collides with the HARQ process, transmitting a further feedback to the data to the second device for the HARQ process.

In some embodiments, the apparatus further comprises means for in response to receiving data from the second device, selecting a candidate HARQ process; means for in accordance with a determination that the candidate HARQ process collides with the HARQ process, obtaining priority information of the scheduling release indication and the data from the control information; and means for in accordance with a determination that the scheduling release indication has higher priority than the data, transmitting a further feedback to the data to the second device on the HARQ.

In some embodiments, the first device comprises a terminal device and the second device comprises a network device.

In some example embodiments, a second apparatus capable of performing any of the method 500 (for example, the second device 120) may comprise means for performing the respective operations of the method 500. The means may be implemented in any suitable form. For example, the means may be implemented in a circuitry or software module. In some embodiments, the means may comprise at least one processor and at least one memory including computer program code. The at least one memory and computer program code are configured to, with the at least one processor, cause performance of the apparatus. The first apparatus may be implemented as or included in the second device 120.

In some embodiments, the apparatus comprises means for transmitting, at a second device, control information comprising a scheduling release indication to a first device; and means for receiving from the first device a feedback on a hybrid automatic repeat request, HARQ, process associated with the scheduling release indication.

In some embodiments, the means for transmitting the control information comprises means for determining a value toggled in association with the scheduling release indication; and means for transmitting the value as at least a part of the control information to the first device.

In some embodiments, the apparatus further comprises means for extracting the value from the feedback; and means for determining based on the value that the feedback is associated with the scheduling release indication.

In some embodiments, the means for transmitting the control information comprises means for in accordance with a determination that data is to be transmitted to the first device, determining priority information of the scheduling release indication and the data; and means for transmitting the priority information as at least a part of the control information to the first device.

In some embodiments, the first device comprises a terminal device and the second device comprises a network device.

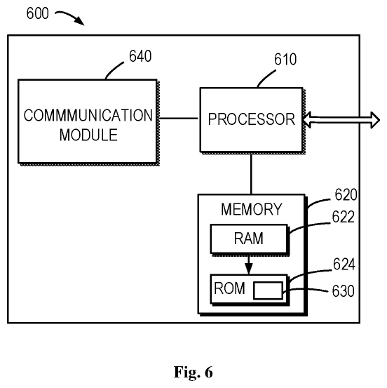

FIG. 6 is a simplified block diagram of a device 600 that is suitable for implementing example embodiments of the present disclosure. The device 600 may be provided to implement a communication device, for example, the first device 110 or the second device 120 as shown in FIG. 1. As shown, the device 600 includes one or more processors 610, one or more memories 620 coupled to the processor 610, and one or more communication modules 840 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the memory, e.g., ROM 624. The processor 610 may perform any suitable actions and processing by loading the program 630 into the RAM 622.

The some example embodiments of the present disclosure may be implemented by means of the program 630 so that the device 600 may perform any process of the disclosure as discussed with reference to FIGS. 2 to 5. The example embodiments of the present disclosure may also be implemented by hardware or by a combination of software and hardware.

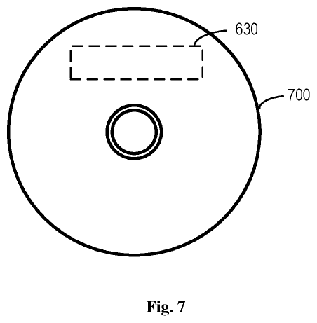

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and other magnetic storage and/or optical storage. FIG. 7 shows an example of the computer readable medium 700 in form of an optical storage disk. The computer readable medium has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target physical or virtual processor, to carry out any of the methods as described above with reference to FIGS. 2 to 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first device comprising:
at least one processor; and
at least one memory including computer program codes;
the at least one memory and the computer program codes are configured to, with the at least one processor, cause the first device to:
receive, from a second device, control information comprising a scheduling release indication for releasing a configured resource;
select a hybrid automatic repeat request, HARQ, process to be associated with the scheduling release indication; and
transmit a feedback to the scheduling release indication to the second device on an occasion allocated for the selected HARQ process.

2. The first device of claim 1, wherein the HARQ process is selected based on a time slot on which the control information is received.

3. The first device of claim 1, wherein the scheduling release indication is for releasing a configured scheduling resource or a semi-static scheduling resource.

4. The first device of claim 1, wherein the first device is caused to select the HARQ process by:
selecting a subsequent HARQ process after a last HARQ process used for data transmission as the HARQ process.

5. The first device of claim 1, wherein the first device is caused to select the HARQ process by:
selecting a subsequent HARQ process which is after a last HARQ process used for data transmission on the configured resource being released by the release indication.

6. The first device of claim 1, wherein the first device is caused to transmit the feedback by:
extracting a first value from the control information, the first value being toggled in association with the scheduling release indication; and
transmitting the first value as at least a part of the feedback to the second device.

7. The first device of claim 1, wherein the first device is caused to transmit the feedback by:
in response to receiving the scheduling release indication, determining a second value which is toggled in association with the reception of the scheduling release indication; and
transmitting the second value as at least a part of the feedback to the second device.

8. The first device of claim 1, wherein the first device is further caused to:
in response to receiving data from the second device, select a candidate HARQ process;
in accordance with a determination that the candidate HARQ process collides with the HARQ process, extract a third value from the control information, the third value being toggled in association with the data; and
transmit a further feedback to the data to the second device for the HARQ process.

9. The first device of claim 1, wherein the first device is further caused to:
in response to receiving data from the second device, select a candidate HARQ process;
in accordance with a determination that the candidate HARQ process collides with the HARQ process, determine a fourth value which is toggled in association with the reception of the data; and
transmit a further feedback to the second device, the further feedback comprising the fourth value.

10. The first device of claim 1, wherein the first device is further caused to:
in response to receiving data from the second device, select a candidate HARQ process; and
in accordance with a determination that the candidate HARQ process collides with the HARQ process, transmit a further feedback to the data to the second device for the HARQ process.

11. The first device of claim 1, wherein the first device is further caused to:
in response to receiving data from the second device, select a candidate HARQ process;
in accordance with a determination that the candidate HARQ process collides with the HARQ process, obtain priority information of the scheduling release indication and the data from the control information; and
in accordance with a determination that the scheduling release indication has higher priority than the data, transmitting a further feedback to the data to the second device on the HARQ.

12. The first device of claim 1, wherein the first device comprises a terminal device and the second device comprises a network device.

13. A second device comprising:
at least one processor; and
at least one memory including computer program codes;
the at least one memory and the computer program codes are configured to, with the at least one processor, cause the second device to:
transmit control information comprising a scheduling release indication to a first device; and
receive from the first device a feedback on an occasion allocated for a hybrid automatic repeat request, HARQ, process associated with the scheduling release indication.

14. A method comprising:
receiving, at a first device and from a second device, control information comprising a scheduling release indication for releasing a configured resource;
selecting a hybrid automatic repeat request, HARQ, process to be associated with the scheduling release indication; and
transmitting a feedback to the scheduling release indication to the second device on an occasion allocated for the selected HARQ process.
